(19) United States
(12) Patent Application Publication
(10) Pub. No.: US 2019/0134943 A1
(43) Pub. Date: May 9, 2019

(54) COMPOSITE FABRIC

(71) Applicant: SAN FANG CHEMICAL INDUSTRY CO., LTD., KAOHSIUNG CITY (TW)

(72) Inventors: KUO-KUANG CHENG, KAOHSIUNG CITY (TW); CHIH-YI LIN, KAOHSIUNG CITY (TW); KAO-LUNG YANG, KAOHSIUNG CITY (TW); CHI-CHIN CHIANG, KAOHSIUNG CITY (TW); TAI-YUN FU, KAOHSIUNG CITY (TW)

(21) Appl. No.: 16/180,550

(22) Filed: Nov. 5, 2018

(30) Foreign Application Priority Data
Nov. 6, 2017 (TW) 106138233

(51) Int. Cl. B32B 5/06; B32B 5/02; B32B 5/26; D04H 1/72

(52) U.S. Cl. CPC B32B 5/06; B32B 5/022; B32B 5/028; B32B 5/26; D04H 1/72; B32B 2250/02; B32B 2262/0253; B32B 2250/24; B32B 2262/0215; B32B 2262/0284; B32B 2262/0292; B32B 2307/51; B32B 2250/20

(57) ABSTRACT

The present disclosure provides a composite fabric including an elastic mesh layer and a non-woven layer. The non-woven layer includes a plurality of non-oriented fibers. The elastic mesh layer is interposed in the non-woven layer, and at least one of the non-oriented fibers extends through the elastic mesh layer.

### BACKGROUND

### 1. Field of the Disclosure

The present disclosure relates to a composite fabric, and more particularly to a composite fabric which can be used for manufacturing artificial leather.

### 2. Description of the Related Art

Generally, artificial leather may be manufactured by impregnating a fibrous substrate in polyurethane or coating the fibrous substrate with polyurethane, and then forming leather-like texture on a surface thereof by pressing. However, if a woven fabric is used as the fibrous substrate, the resultant artificial leather may have poor elasticity and resilience, and the handle (hand feeling) thereof is not acceptable. On the other hand, when a non-woven fabric is used as the fibrous substrate, in order to provide the resultant artificial leather with a dense feeling (firm texture), the non-woven fabric must have a sufficient thickness, thus adversely affecting the elasticity and resilience of the resultant artificial leather.

### SUMMARY

The present invention provides a composite fabric which has favorable elasticity and resilience, and can be used for manufacturing artificial leather.

Hence, the present disclosure provides a composite fabric including an elastic mesh layer and a non-woven layer. The non-woven layer includes a plurality of non-oriented fibers. The elastic mesh layer is interposed in the non-woven layer, and at least one of the non-oriented fibers extends through the elastic mesh layer.

A method for manufacturing a composite fabric, including: (a) providing a fiber web and an elastic mesh layer, wherein the fiber web includes a plurality of non-oriented fibers; (b) stacking the elastic mesh layer and the fiber web together; and (c) entangling the fiber web, such that the non-oriented fibers are tangled with each other to form a non-woven layer, the elastic mesh layer is interposed in the non-woven layer, and at least one of the non-oriented fibers extends through the elastic mesh layer.

### BRIEF DESCRIPTION OF THE DRAWINGS

FIG. 1 illustrates a cross sectional view of a composite fabric according to some embodiments of the present disclosure.

FIG. 2 illustrates a partial, top view of an elastic mesh layer of the composite fabric shown in FIG. 1.

FIG. 3 illustrates a flow chart of a method for manufacturing a composite fabric according to some embodiments of the present disclosure.

FIG. 4 illustrates a cross sectional view of a fiber web according to some embodiments of the present disclosure.

FIG. 5 illustrates a partial, top view of an elastic mesh layer according to some embodiments of the present disclosure.

FIG. 6 illustrates a cross sectional view of an elastic mesh layer interposed in a fiber web according to some embodiments of the present disclosure.

### DETAILED DESCRIPTION

The present disclosure provides for a composite fabric including an elastic mesh layer and a non-woven layer. The non-woven layer includes a plurality of non-oriented fibers. The elastic mesh layer is interposed in the non-woven layer, and at least one of the non-oriented fibers extends through the elastic mesh layer.

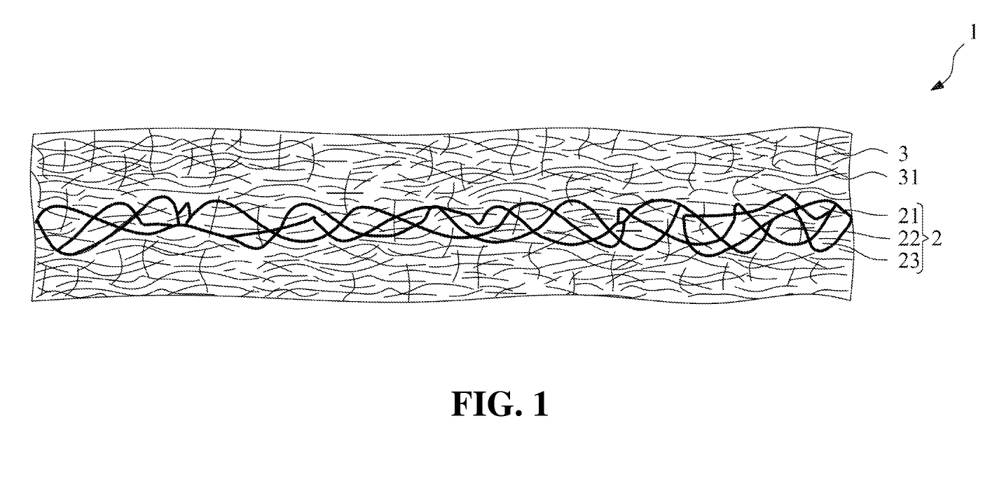

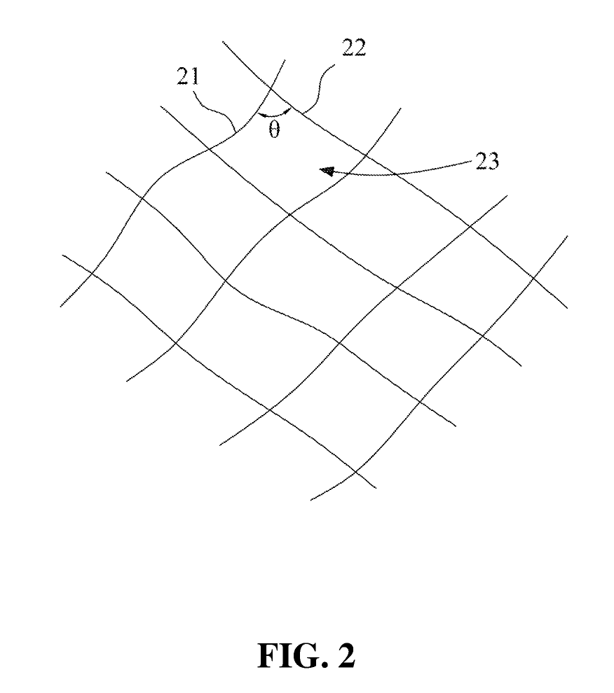

FIG. 1 illustrates a cross sectional view of a composite fabric 1 according to some embodiments of the present disclosure. The composite fabric 1 includes an elastic mesh layer 2 and a non-woven layer 3. FIG. 2 illustrates a partial, top view of the elastic mesh layer 2 of the composite fabric 1.

The elastic mesh layer 2 is interposed in the non-woven layer 3. For example, a distance between the elastic mesh layer 2 and a surface of the non-woven layer 3 may be one-half to one-third of a thickness of the non-woven layer 3. That is, the elastic mesh layer 2 may be located at a central region along a thickness direction of the non-woven layer 3, or slightly above or below the central region.

In an embodiment, of the present disclosure, the elastic mesh layer 2 is made of a thermoplastic elastomer. For example, the thermoplastic elastomer is selected from a group consisting of thermoplastic polyurethane (TPU), thermoplastic polyester elastomer (TPEE), and thermoplastic polyolefin (TPO). The TPUs, for example, includes polyester-based TPUs, which are mainly derived from adipic acid esters; and polyether-based TPUs, which are mainly based on tetrahydrofuran (THF) ethers. The TPEEs, for example, includes thermoplastic copolyester elastomer having hard segments based on polybutylene terephthalate (PBT) and polytetrahydrofuran (PTMEG), and soft segments based on polyester polyol, e.g., poly(butyl acrylate). The TPOs, for example, includes blends of TPO with ethylene propylene rubber (EPM) or ethylene propylene diene rubber (EPDM), or ternary mixture of EPMs, EPDMs and two kinds of polyolefin (e.g., polyethylene, polypropylene, poly-1-butene). However, these are not to be taken in a limiting sense. In an embodiment of the present disclosure, a Shore A hardness of the thermoplastic elastomer may be 45 A to 90 A, such as 55 A to 80 A, or 60 A to 70 A.

The elastic mesh layer 2 may include a plurality of first oriented fibers 21 and a plurality of second oriented fibers 22. The term “oriented fibers” may be long fibers, and may extend in a horizontal direction of the elastic mesh layer 2 through the whole elastic mesh layer 2. Preferably, the oriented fibers extend in a straight line. The first oriented fibers 21 extend substantially in a first direction and substantially parallel to each other. The second oriented fibers 22 extend substantially in a second direction and substantially parallel to each other. The first oriented fibers 21 along the first direction intersects with the second oriented fibers 22 along the second direction at a plurality of intersections, such that a plurality of mesh holes 23 are defined between the first oriented fibers 21 and the second oriented fibers 22. The first oriented fibers 21 and the second oriented fibers 22 are fused with each other at the intersections. For example, an angle 0 between the first direction and the second direction is 15 degrees to 90 degrees. It is readily appreciated that, at each intersection, the first direction and the second direction forms two angles supplement to each other. One of the two angles may be 15 degrees to 90 degrees (e.g., 15 degrees to 30 degrees, 30 degrees to 60 degrees, or 60 degrees to 90 degrees), and the other one of the two angles may be 90 degrees to 165 degrees (e.g., 150 degrees to 165 degrees, 120 degrees to 150 degrees, or 90 degrees to 120 degrees). Besides, such angles may be measured when the elastic mesh layer 2 is not stretched (e.g., in a loose state).

Each of the mesh holes 23 has two diagonals. When the angle between the first direction and the second direction is not equal to 90°, the two diagonals include a longer one and a shorter one. Generally, elasticity of the elastic mesh layer 2 may be higher along a direction of the shorter one of the two diagonals, and may be lower along a direction of the longer one of the two diagonals.

The first oriented fibers 21 and/or the second oriented fibers 22 are substantially equally spaced, and a distance between adjacent two of the first oriented fibers 21 or the second oriented fibers 22 is 3 mm to 7 mm. In an embodiment of the present disclosure, the distance between adjacent two of the first oriented fibers 21 may be measured along the second direction, and the distance between adjacent two of the second oriented fibers 22 may be measured along the first direction.

In an embodiment of the present disclosure, the distance between adjacent two of the first oriented fibers 21 may substantially equal to the distance between adjacent two of the second oriented fibers 22. That is, the mesh holes 23 may have a rhombus or square shape. Alternatively, in another embodiment of the present disclosure, the distance between adjacent two of the first oriented fibers 21 may not equal to the distance between adjacent two of the second oriented fibers 22. Hence, the mesh holes 23 may have rhomboid or rectangle shape.

In an embodiment of the present disclosure, a diameter of the first oriented fibers 21 and/or the second oriented fibers 22 is 0.03 mm to 0.4 mm. The diameter of the first oriented fibers 21 may be substantially the same as or different from the diameter of the second oriented fibers 22, which is not limited in the present disclosure. In an embodiment, the diameter of the first oriented fibers 21 is substantially equal to the diameter of the second oriented fibers 22, such that the structural strength of the elastic mesh layer 2 may be more consistent or even.

The non-woven layer 3 includes a plurality of non-oriented fibers 31. At least one of the non-oriented fibers 31 extends through the elastic mesh layer 2. The term “non-oriented fibers” may be short fibers which are arranged randomly, and directions thereof may be different from each other. Generally, the non-oriented fibers 31 may not extend in a straight line, and is not necessary to be parallel to the horizontal direction of the non-woven layer 3. The non-oriented fibers 31 are tangled with each other to form the non-woven layer 3, and at least one of them may extend through one of the mesh holes 23, thus extends through the elastic mesh layer 2. In an embodiment of the present disclosure, a length of the non-oriented fibers 31 may be 15 mm to 70 mm, and a fineness thereof may be 1.2 den to 12 den. Preferably, the length of the non-oriented fibers 31 is 20 mm to 60 mm, and the fineness thereof is 1.5 den to 9 den.

In the composite fiber 1, since the non-oriented fibers 31 are tangled with each other, and since at least one of the non-oriented fibers 31 extends through the elastic mesh layer 2, the elastic mesh layer 2 may be pulled or dragged by the non-oriented fibers 31, thus may not be planar. That is, the elastic mesh layer 2 may be not a flat plane. As shown in FIG. 1, in a direction perpendicular to a surface of the non-woven layer 3, the elastic mesh layer 2 may have a topmost point and a bottommost point, and a level difference between the topmost point and the bottommost point is greater than twice of the diameter of the first oriented fibers 21 or the second oriented fibers 21, such as greater than triple of the diameter of the first oriented fibers 21 or the second oriented fibers 21.

In the composite fabric 1 of the present disclosure, due to the favorable elasticity of the elastic mesh layer 2, the resultant composite fabric 1 is provided with favorable elasticity and resilience. Meanwhile, the non-woven layer 3 provides the non-oriented fibers 31 to makes the elastic mesh layer 2 fixed and interposed in the non-woven layer 3. The non-woven layer 3 further provides the composite fabric 1 with a leather-like surface texture, and thus, the composite fabric 1 has excellent handle (hand feeling) and dense feeling (firm texture). Accordingly, the composite fabric 1 may be utilized in the art field of artificial leather or other fabric-related application. Further, due to the aforementioned properties, the composite fabric 1 may be manufactured into artificial leather without being impregnated in polyurethane or coated with polyurethane.

The present disclosure further provides for a method for manufacturing a composite fabric, including: (a) providing a fiber web and an elastic mesh layer, wherein the fiber web includes a plurality of non-oriented fibers; (b) stacking the elastic mesh layer and the fiber web together; and (c) entangling the fiber web, such that the non-oriented fibers are tangled with each other to form a non-woven layer, the elastic mesh layer is interposed in the non-woven layer, and at least one of the non-oriented fiber extends through the elastic mesh layer.

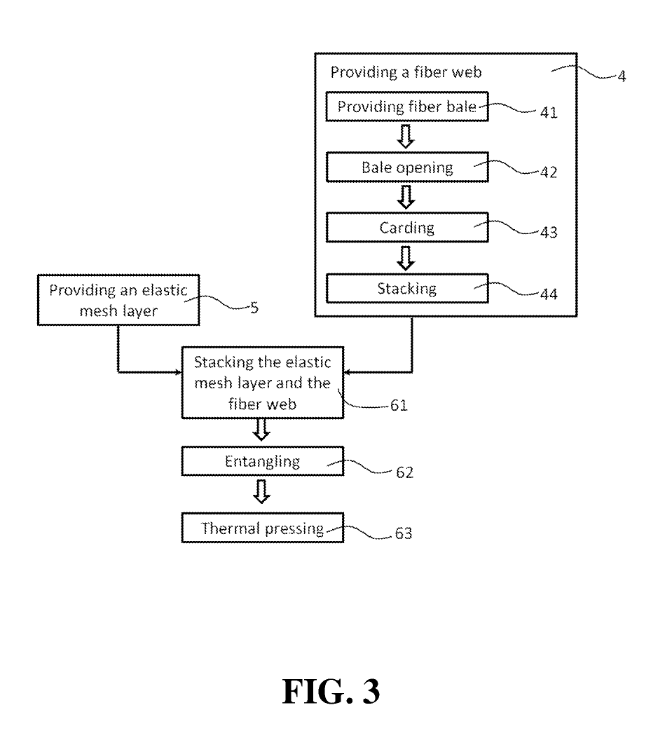

FIG. 3 illustrates a flow chart of a method for manufacturing a composite fabric according to some embodiments of the present disclosure. Such method may be used for manufacturing the aforementioned composite fabric 1.

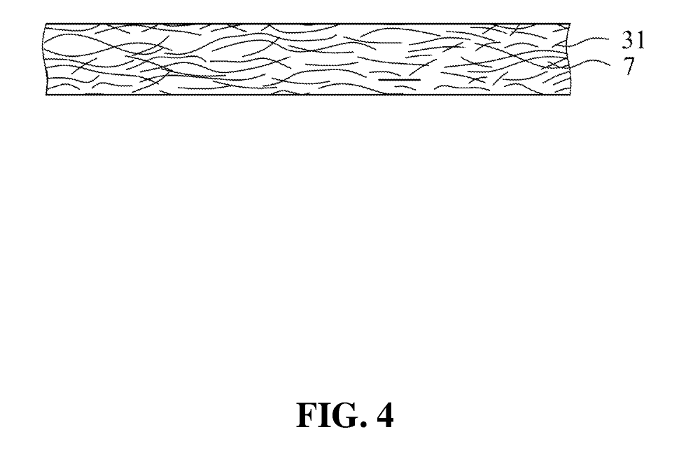

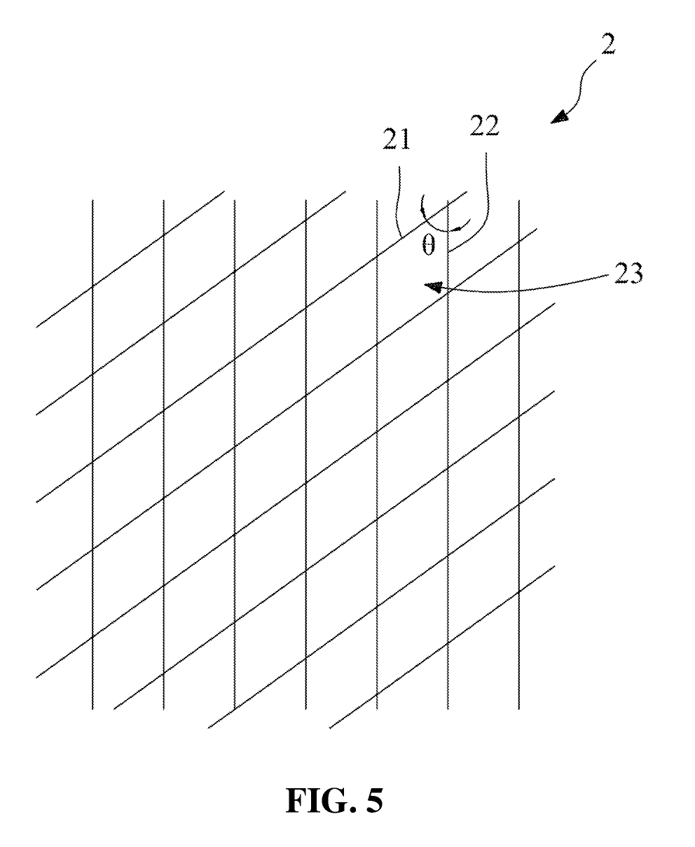

Firstly, a fiber web 7 (Step 4) and an elastic mesh layer 2 (Step 5) are provided. The fiber web 7 may be as shown in FIG. 4, and the elastic mesh layer 2 may be as shown in FIG. 5. The fiber web 7 may already be entangled, or may not be entangled. The elastic mesh layer 2 may include a plurality of first oriented fibers 21 and a plurality of second oriented fibers 22, and defines mesh holes 23 therebetween.

Generally, a manufacturing process of a non-woven fabric may include steps of providing fiber bale, bale opening, carding, stacking, entangling (e.g., needle punching or spunlacing), thermal pressing, etc. Accordingly, the term “non-entangled fiber web 7” refers to the fiber web before the entangling step, but may be after the steps of bale opening, carding and/or stacking, which is not limited in the present disclosure.

According to the above, in the present disclosure, the step of providing the fiber web 7 (Step 4) may include providing fiber bale (Step 41), bale opening (Step 42), carding (Step 43), stacking (Step 44), etc.

In the step of providing fiber bale (Step 41), the fiber bale is composed of a plurality of non-oriented fibers 31 packaged in the bale. The materials and properties of the non-oriented fibers 3 are as described above, thus are not repeated redundantly. In the bale opening step (Step 42), the bale of the non-oriented fibers 31 are made into batts, which is smaller than the bale. In the carding step (Step 43), the batts are combed into fluffy and loosened fiber webs 7. FIG. 4 illustrates a cross sectional view of the fiber web 7. Then, in the stacking step (Step 44), the fiber webs 7 are stacked together to a predetermined thickness.

FIG. 5 illustrates a partial, top view of the elastic mesh layer 2. The elastic mesh layer 2 may be made of a thermoplastic elastomer, such as the aforementioned thermoplastic elastomers. In an embodiment of the present disclosure, a Shore A hardness of the thermoplastic elastomer may be 45 A to 90 A, such as 55 A to 80 A, or 60 A to 70 A.

The elastic mesh layer 2 may include a plurality of first oriented fibers 21 and a plurality of second oriented fibers 22. The term “oriented fibers” may be long fibers, and may extend in a horizontal direction of the elastic mesh layer 2 through the whole elastic mesh layer 2. Preferably, the oriented fibers extend in a straight line. The first oriented fibers 21 extend substantially in a first direction and substantially parallel to each other. The second oriented fibers 22 extend substantially in a second direction and substantially parallel to each other. The first oriented fibers 21 along the first direction intersects with the second oriented fibers 22 along the second direction at a plurality of intersections, such that a plurality of mesh holes 23 are defined between the first oriented fibers 21 and the second oriented fibers 22. The first oriented fibers 21 and the second oriented fibers 22 are fused with each other at the intersections. For example, an angle θ between the first direction and the second direction is 15 degrees to 90 degrees. It is readily appreciated that, at each intersection, the first direction and the second direction forms two angles supplement to each other. One of the two angles may be 15 degrees to 90 degrees, and the other one of the two angles may be 90 degrees to 165 degrees. Besides, such angles may be measured when the elastic mesh layer 2 is not stretched (e.g., in a loose state).

Each of the mesh holes 23 has two diagonals. When the angle between the first direction and the second direction is not equal to 90°, the two diagonals include a longer one and a shorter one. Generally, elasticity of the elastic mesh layer 2 may be higher along a direction of the shorter one of the two diagonals, and may be lower along a direction of the longer one of the two diagonals.

The first oriented fibers 21 and/or the second oriented fibers 22 are substantially equally spaced, and a distance between adjacent two of the first oriented fibers 21 or the second oriented fibers 22 is 3 mm to 7 mm. In an embodiment of the present disclosure, the distance between adjacent two of the first oriented fibers 21 may be measured along the second direction, and the distance between adjacent two of the second oriented fibers 22 may be measured along the first direction.

In an embodiment of the present disclosure, the distance between adjacent two of the first oriented fibers 21 may substantially equal to the distance between adjacent two of the second oriented fibers 22. That is, the mesh holes 23 may have a rhombus or square shape. Alternatively, in another embodiment of the present disclosure, the distance between adjacent two of the first oriented fibers 21 may not equal to the distance between adjacent two of the second oriented fibers 22. Hence, the mesh holes 23 may have rhomboid or rectangle shape.

In an embodiment of the present disclosure, a diameter of the first oriented fibers 21 and/or the second oriented fibers 22 is 0.03 mm to 0.4 mm. The diameter of the first oriented fibers 21 may be substantially the same as or different from the diameter of the second oriented fibers 22, which is not limited in the present disclosure. In an embodiment, the diameter of the first oriented fibers 21 is substantially equal to the diameter of the second oriented fibers 22, such that the structural strength of the elastic mesh layer 2 may be more consistent or even.

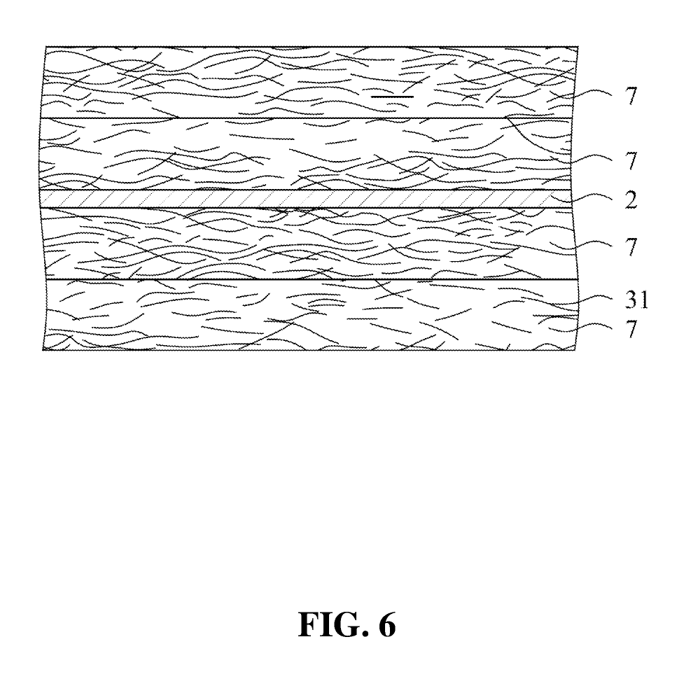

After the fiber web 7 is formed, the elastic mesh layer 2 and the fiber web 7 are stacked together (Step 61). The elastic mesh layer 2 may be disposed on the fiber web 7, or may be interposed in the fiber web 7. FIG. 6 illustrates a cross sectional view of the elastic mesh layer 2 interposed in the fiber web 7, but is not to be taken in a limiting sense. Each mesh hole 23 of the elastic mesh layer 2 has two diagonals, as described above, when the angle between the first direction of the first oriented fibers 21 and the second direction of the second oriented fibers 22 is not equal to 90 degrees, one of the two diagonals is shorter. Thus, elasticity of the mesh layer 2 is anisotropic. Accordingly, by adjusting the orientation of the elastic mesh layer 2 relative to the fiber web 7, the elastic property of the resultant composite fabric 1 may be varied. For example, a non-woven fabric generally has lower elasticity along a machine direction (MD, i.e., direction of carding), and the elasticity thereof is higher along a cross direction (CD, i.e., perpendicular to carding direction). Hence, stacking the elastic mesh layer 2 and the fiber web 7 with the shorter one of the two diagonal parallel to the direction of carding may balance elastic anisotropy of the non-woven fabric, thus providing the resultant composite fabric 1 with an elasticity which is more consistent or even in every direction. Alternatively, stacking the elastic mesh layer 2 and the fiber web 7 with the shorter one of the two diagonals perpendicular to the direction of carding may enhance elastic anisotropy of the non-woven fabric. The resultant composite fabric 1 with an anisotropic elasticity may be suitable for particular applications.

Then, the fiber web 7 is entangled (Step 62), e.g., by needle punching or spunlacing, such that the non-oriented fibers 31 are tangled with each other to form a non-woven layer 3. The elastic mesh layer 2 is interposed in the non-woven layer 3, and at least one of the non-oriented fibers 31 extends through the elastic mesh layer 2. In step 62, the punching needles may repeatedly move upward and downward through the fiber web 7, thus pulling or dragging the non-oriented fibers 31 through the elastic mesh layer 2, and making the non-oriented fibers 31 tangled with each other. Thus, the non-oriented fibers 31 form the non-woven layer 3, and the elastic mesh layer 2 is fixed in the non-woven layer 3. Since the non-oriented fibers 31 may be pulled or dragged by the punching needles, even if the elastic mesh layer 2 is disposed on the fiber web 7, some of the non-oriented fibers 31 may still be moved to above the elastic mesh layer 2 during the entangling process. Hence, after entangling, the elastic mesh layer 2 may readily be interposed in the non-woven layer 3. That is, the elastic mesh layer 2 may be disposed within the non-woven layer 3.

Optionally, after the non-woven layer 3 is formed, the non-woven layer 3 and the elastic mesh layer 2 may then be thermal pressed (e.g., by using a hot press roller), such that the non-oriented fibers 3 may be tightly bonded with each other. The thickness of the composite fabric 1 may be adjusted by thermal pressing process, and structural strength thereof may also be improved. The temperature of the thermal pressing process is not limited in the present disclosure, but preferably between a softening point and a melting point of the elastic mesh layer 2.

The following examples are given for illustrating the method for manufacturing the composite fabric of the present disclosure, but are not intended to limit the scope of the present invention

### EXAMPLE 1

Short fibers of PET (fineness: 3 den, length: 51 mm) are provided in a bale, and the bale is opened (feed rate: 200 kg/min) in a non-woven production line. Then, the opened batts are fed to a carding machine for carding process, thus forming fiber webs.

The fiber webs are stacked with each other to form a fiber web having a height of 10 cm, a width of 200 cm, and a unit weight of 250 g/m². Before entangling, an elastic mesh layer is interposed into the fiber web. The elastic mesh layer is made of TPU. A diameter of first oriented fibers and a diameter of the second oriented fibers in the elastic mesh layer are both 0.08 mm. An angle between the first oriented fiber and the second oriented fibers is 30 degrees (and 150 degrees). A distance between adjacent two of the first oriented fibers and a distance between adjacent two of the second oriented fibers are both 5 mm.

Then, the fiber web is needle punched. After repeating the needle punching process for six times (e.g., passing through six needling punching machines), a non-woven layer is formed with a thickness of 1.3 mm, and the elastic mesh layer is interposed in the non-woven layer.

Then, the non-woven layer and the elastic mesh layer may be thermal pressed by a hot press roller with a surface temperature of 135° C., thus forming a composite fabric with a thickness of 1.0 mm. Tensile strength and elongation at break (ASTM D1682), and tear strength (ASTM D2262 & D1777) of the resultant composite fabric (Example 1) are shown in Table 1 below. In Table 1, “MD” refers to machine direction, and “CD” refers to cross direction which is perpendicular to the machine direction.

The aforementioned materials and method are utilized to form a non-woven fabric without an elastic mesh layer (Comparative Example 1), and the tensile strength, elongation at break and tear strength thereof are also shown in Table 1 below.

### EXAMPLE 2

Separated-type micro fibers (fineness: 4.5 den, length: 51 mm) are provided in a bale, and the bale is opened (feed rate: 280 kg/min) in a non-woven production line. Then, the opened batts are fed to a carding machine for carding process, thus forming fiber webs.

The fiber webs are stacked with each other to form a fiber web having a height of 13 cm, a width of 200 cm, and a unit weight of 320 g/m². Before entangling, an elastic mesh layer is interposed into the fiber web. The elastic mesh layer is made of TPEE. A diameter of first oriented fibers and a diameter of the second oriented fibers in the elastic mesh layer are both 0.12 mm. An angle between the first oriented fiber and the second oriented fibers is 60° (and 120°). A distance between adjacent two of the first oriented fibers and a distance between adjacent two of the second oriented fibers are both 5 mm.

Then, the fiber web is needle punched. After repeating the needle punching process for six times (e.g., passing through six needling punching machines), a non-woven layer is formed with a thickness of 1.7 mm, and the elastic mesh layer is interposed in the non-woven layer.

Then, the non-woven layer and the elastic mesh layer may be thermal pressed by a hot press roller with a surface temperature of 125° C., thus forming a composite fabric with a thickness of 1.4 mm. Tensile strength and elongation at break (ASTM D1682), and tear strength (ASTM D2262 & D1777) of the resultant composite fabric (Example 2) are shown in Table 1 below.

The aforementioned materials and method are utilized to form a non-woven fabric without an elastic mesh layer (Comparative Example 2), and the tensile strength, elongation at break and tear strength thereof are also shown in Table 1 below.

### EXAMPLE 3

Separated-type micro fibers (fineness: 4 den, length: 51 mm) are provided in a bale, and the bale is opened (feed rate: 150 kg/min) in a non-woven production line. Then, the opened batts are fed to a carding machine for carding process, thus forming fiber webs.

The fiber webs are stacked with each other to form a fiber web having a height of 9 cm, a width of 200 cm, and a unit weight of 200 g/m². Before entangling, an elastic mesh layer is interposed into the fiber web. The elastic mesh layer is made of TPO. A diameter of first oriented fibers and a diameter of the second oriented fibers in the elastic mesh layer are both 0.03 mm. An angle between the first oriented fiber and the second oriented fibers is 90°. A distance between adjacent two of the first oriented fibers and a distance between adjacent two of the second oriented fibers are both 5 mm.

Then, the fiber web is needle punched. After repeating the needle punching process for six times (e.g., passing through six needling punching machines), a non-woven layer is formed with a thickness of 1.0 mm, and the elastic mesh layer is interposed in the non-woven layer.

Then, the non-woven layer and the elastic mesh layer may be thermal pressed by a hot press roller with a surface temperature of 145° C., thus forming a composite fabric with a thickness of 0.8 mm. Tensile strength and elongation at break (ASTM D1682), and tear strength (ASTM D2262 & D1777) of the resultant composite fabric (Example 3) are shown in Table 1 below.

The aforementioned materials and method are utilized to form a non-woven fabric without an elastic mesh layer (Comparative Example 3), and the tensile strength, elongation at break and tear strength thereof are also shown in Table 1 below.

TABLE 1
Physical properties of Examples 1 to 3 and Comparative Examples 1 to 3

| | Tensile | | Elongation | | | | |
|---|---|---|---|---|---|---|---|
| | Strength | | at Break | | Tear Strength | | Elastic |
| | (kgf) | | (%) | | (kgf) | | Recovery |
| | MD | CD | MD | CD | MD | CD | (%) |
| Example 1 | 40.0 | 38.2 | 124 | 170 | 18.8 | 14.3 | 8 |
| Comparative | 32.2 | 28.2 | 102 | 156 | 13.4 | 10.2 | 1.5 |
| Example 1 | | | | | | | |
| Example 2 | 45.4 | 42.5 | 138 | 175 | 24.7 | 21.7 | 7 |
| Comparative | 40.0 | 36.0 | 122 | 163 | 20.7 | 16.9 | 2 |
| Example 2 | | | | | | | |
| Example 3 | 38.3 | 35.1 | 117 | 142 | 21.5 | 16.9 | 5 |
| Comparative | 30.7 | 28.0 | 104 | 133 | 12.2 | 10.8 | 2.8 |
| Example 3 | | | | | | | |

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A composite fabric, comprising:
an elastic mesh layer; and
a non-woven layer comprising a plurality of non-oriented fibers;
wherein the elastic mesh layer is interpose in the non-woven layer, and at least one of the non-oriented fibers extends through the elastic mesh layer.

2. The composite fabric of claim 1, wherein the elastic mesh layer comprises:
a plurality of first oriented fibers extending substantially in a first direction and substantially parallel to each other; and
a plurality of second oriented fibers extending substantially in a second direction and substantially parallel to each other;
wherein the first direction intersects with the second direction, such that a plurality of mesh holes are defined between the firs oriented fibers and the second oriented fibers, and the first oriented fibers and the second oriented fibers are fused with each other at intersections.

3. The composite fabric of claim 2, wherein an angle between the first direction and the second direction is in a range of 15 degrees to 90 degrees.

4. The composite fabric of claim 2, wherein a level difference between a topmost point and a bottommost point of the elastic mesh layer is greater than triple of a diameter of the first oriented fibers or the second oriented fibers.

5. The composite fabric of claim 2, wherein the first oriented fibers and/or the second oriented fibers are substantially equally spaced, and a distance between adjacent two of the first oriented fibers or the second oriented fibers is in a range of 3 mm to 7 mm.

6. The composite fabric of claim 2, wherein the elastic mesh layer is made of a thermoplastic elastomer.

7. The composite fabric of claim 1, wherein a distance between the elastic mesh layer and a surface of the non-woven layer is in a range of one-half to one-third of a thickness of the non-woven layer.

8. A method for manufacturing a composite fabric, comprising:
(a) providing a fiber web and an elastic mesh layer, wherein the fiber web includes a plurality of non-oriented fibers;
(b) stacking the elastic mesh layer and the fiber web together; and
(c) entangling the fiber web, such that the non-oriented fibers are tangled with each other to form a non-woven layer, the elastic mesh layer is interposed in the non-woven layer, and at least one of the non-oriented fibers extends through the elastic mesh layer.

9. The method of claim 8, further comprising:
(a1) providing the plurality of non-oriented fibers; and
(a2) opening and carding the non-oriented fibers to form the fiber web.

10. The method of claim 9, wherein the elastic mesh layer defines a plurality of mesh holes, each of the mesh holes has two diagonals, and in step (b), the elastic mesh layer and the fiber web are stacked with a shorter one of the two diagonals of the elastic mesh layer parallel to a direction of carding.
